(19) United States
(12) Patent Application Publication
(10) Pub. No.: US 2021/0073882 A1
(43) Pub. Date: Mar. 11, 2021

(54) System and method for enhancing the in-store customer shopping experience

(71) Applicant: Mark Park, Toronto (CA)

(72) Inventor: Mark Park, Toronto (CA)

(21) Appl. No.: 17/008,766

(22) Filed: Sep. 1, 2020

Related U.S. Application Data
(60) Provisional application No. 62/896,686, filed on Sep. 6, 2019.

(51) Int. Cl. G06Q 30/06; G06Q 30/02; G06Q 20/32; G06Q 10/10; G06F 16/955; G06K 7/14; G06K 7/10; H04L 29/06; G06F 40/174; G06F 40/143; G06F 3/0482

(52) U.S. Cl. CPC G06Q 30/0613; G06F 3/0482; G06Q 30/0643; G06Q 30/0633; G06Q 30/0222; G06Q 30/0282; G06Q 20/3276; G06Q 30/0236; G06Q 10/107; G06F 16/9558; G06K 7/1413; G06K 7/10722; H04L 63/083; G06F 40/174; G06F 40/143; G06Q 30/0623

(57) ABSTRACT

A system and method carried out on an Internet enabled user device for enhancing the in-store customer shopping experience that requires no registrations, logins, or mobile app for the customer and no new hardware, installation, or integration required for the retailer. A simple, cloud-based, customer-driven online marketing toolset for retailers that offer “one-click” solutions to meet the individual needs of their customers. In turn, increasing the lifetime value of each customer to build profitable customer relationships for the retailer. The invention comprises of a web page comprising a user-interactive, multimedia, HTML (hypertext markup language) web form with one or more modularized HTML user-interactive fields that can be enabled, disabled, or edited on the fly. The invention aggregates key shopping elements valuable to customers that include a “Surprise Savings” checkout discount every time they shop, real-time “Flash, Daily Deal and Clearance” sales, iframed external web pages such as weekly flyers, request for in-store assistance, inquire about unavailable products, request a discount on desired products while customer is in-store, or to be notified upon price reductions on desired products. No verbal communication required.

### CROSS-REFERENCES TO RELATED APPLICATIONS

This application claims benefit of provisional application 62/896,686 filed on Sep. 6, 2019

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### Field of the Invention

This invention pertains to web-based software applications. More specifically, the invention comprises a method and system for enhancing the in-store customer shopping experience by aggregating simple customer-driven tools to meet the purchasing needs of each customer, and build profitable customer relationships for retailers.

### Description of the Related Art

In recent years, the Internet and online businesses has disrupted brick and mortar retailers, and many of these retailers face the challenge of being more relevant in a digital era within highly competitive markets.

Despite the digital era, there are customers who prefer to buy and pick up products locally at retail stores. Thus, retailers must shift their focus towards more customer-driven tools that meet the purchasing needs of each customer, providing immediate value such as savings, service, and convenience to increase retention.

Moreover, a simple automated method that empowers customers to negotiate a better price with the business, requiring no verbal communication or personal information.

Retail shopping is not dying, but a painful transformation has begun for brick and mortar experiences—enhancing the customer shopping experience is more important than ever.

Furthermore, giving proactive in-store tools that give customers the ability to initiate input and satisfy their individual purchasing needs, which encourage visits to a retail store. In addition, a simple aggregated toolset that offers customers instant gratification to increase sales and maximize their lifetime value for the retailer.

However, many known software applications developed for the retail marketplace such as Enterprise Resource Planning (ERP) software, Point of Sale (POS) software, Beacon technology, Supply Chain Management Software (SCMS), or Customer Relationship Management (CRM) software are primarily product or management focused, and less customer focused. Moreover, the related art is costly, as it requires new hardware, integration and installation.

For the most part, retailers lack in offering instant gratification to customers as many are still operating in the conventional product or management focused business model, rather than deploying an approach that is more customer-driven.

There are customer-focused websites and mobile app tools available today for customers such as digital weekly flyers, digital coupons, reward programs, loyalty cards, delivery services, and customer feedback, but many of these tools may not necessarily increase customer loyalty or revenue for the retailer.

In addition, many tools are single objective applications that may not receive much usage nor activity by the customer due to reasons such as:
1. Lack of value (e.g. does not save customer money, or money saved is not worth the effort)
2. Inconvenience (e.g. requires customer to visit different websites or applications)
3. Complexity (e.g. requires many computer mouse clicks to satisfy objective).
4. Registration (e.g. reluctance to sign-up and disclose personal information)
5. Privacy (e.g. customer info & activity tracked via their mobile phone app)

It is apparent that a need exists for a customer-driven method that offers a standalone tool designed for customers that combine savings, convenience, simplicity and service, as they are paramount decision-making factors to customer purchasing.

Specifically, turnkey customer-driven solutions that require only one or two clicks of the computer mouse to satisfy objectives, and to be equally as simple for retailers to manage at the store level with minimal effort, as it is for customers to adopt and utilize.

Particularly, a tool that requires no registrations, loyalty cards, reward programs, logins, or apps required. Moreover, a simple method and system that allows retailers to improve their existing objectives utilizing the related art such as discount barcodes, promo codes and flash sales for customers; without the typical complexities required for implementation and deployment found in traditional retail management software.

Furthermore, a tool that offers in-store customers a simple way to advise retailers of their purchasing needs and what it is they are seeking to buy, minimizing the number of shoppers leaving the store empty-handed. In turn, retailers automatically obtain valuable pre-sale customer data, to better serve and accommodate customers on a per store basis. This is contrary to customer data acquired by retailers, which is typically based on post-sale customer purchases provided through the related art.

The present invention seeks to aggregate simple customer centric tools that provide value and instant gratification for the customer, to increase sales for retailers.

### SUMMARY OF PRESENT INVENTION AND ADVANTAGES

The present invention comprises savings, convenience and customer service combined in one mobile-friendly, accessible (disability-inclusive), modularized, user-interactive, multimedia, HTML (hypertext markup language) web form with one or more user-interactive fields for in-store customers, accessible via an internet enabled user device.

Particularly, providing customers with dynamic content aggregated in one multimedia HTML web form, accessible through a web page URL that requires no registration, logins, or mobile apps for ease of use. A method and system that provides customers with “one-click” instant gratification to improve service convenience through web-based automation, and minimize their verbal liaison with retailers.

Furthermore, the invention relates to a method and system that empowers in-store customers to advise retailers of products they wish to purchase pending a price reduction, or to receive an email notification by the retailer when desired products have been discounted. In turn, retailers can respond with a product discount code while the shopper is in-store, with no verbal communication or personal information required. Moreover, the invention allows retailers to achieve the challenges of pre-sale customer data on a per store basis in real-time, as well as a sales and service tool for customers.

In addition, the invention relates to a method and system for retailers to offer dynamic discount savings and flash sales for in-store customers in real-time, which retailers can edit on the fly with clicks of a computer mouse.

The present invention combines the following elements, enabling a customer to satisfy the following objectives in one user-interactive, multimedia, HTML web form, accessible via an internet enabled user device:

1. Receive a surprise checkout discount every time they shop.

2. View embedded external web pages, such as weekly flyers.

3. View flash, daily deal and clearance sales in real-time.

4. Request for in-store assistance.

5. Inquire about unavailable products.

6. Request a discount on desired products while in-store.

7. Submit general feedback and suggestions.

Retailers can enable, disable, add, edit, delete, or move any of the seven modularized elements with one click of a computer mouse, via the user device resident application, on the fly.

The present invention can save hands-on time, improve micro marketing efficiency, and increase in-store sales revenue for retailers on a per store basis.

The present invention is advantageous for franchisors, as it allows each of its retail locations to setup and launch the present invention in minutes through downloadable, customizable, predesigned templates that requires no new hardware or software integration. Moreover, to easily acquire the challenges of pre-sale data per store location in real-time, to better serve and accommodate customer purchasing needs on a per store basis, improving marketing efficacy and loyalty.

### BRIEF DESCRIPTION OF THE IMAGES

A clear understanding of the key features of the present invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating. Accordingly:

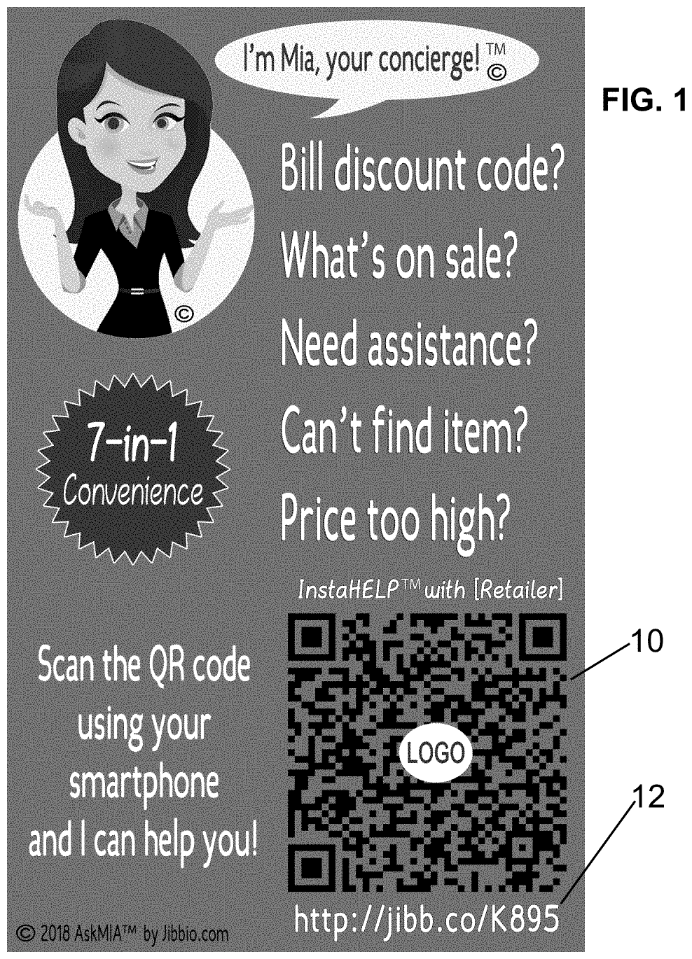

FIG. 1 is an image of printed signage used as a method and system of this invention that allows a customer (user) to use their smartphone to scan a “Quick Response (QR) Code” or enter the “Short Link” displayed, which direct to the URL of a user-interactive, multimedia, HTML web form comprising of one or more HTML user-interactive fields, the invention.

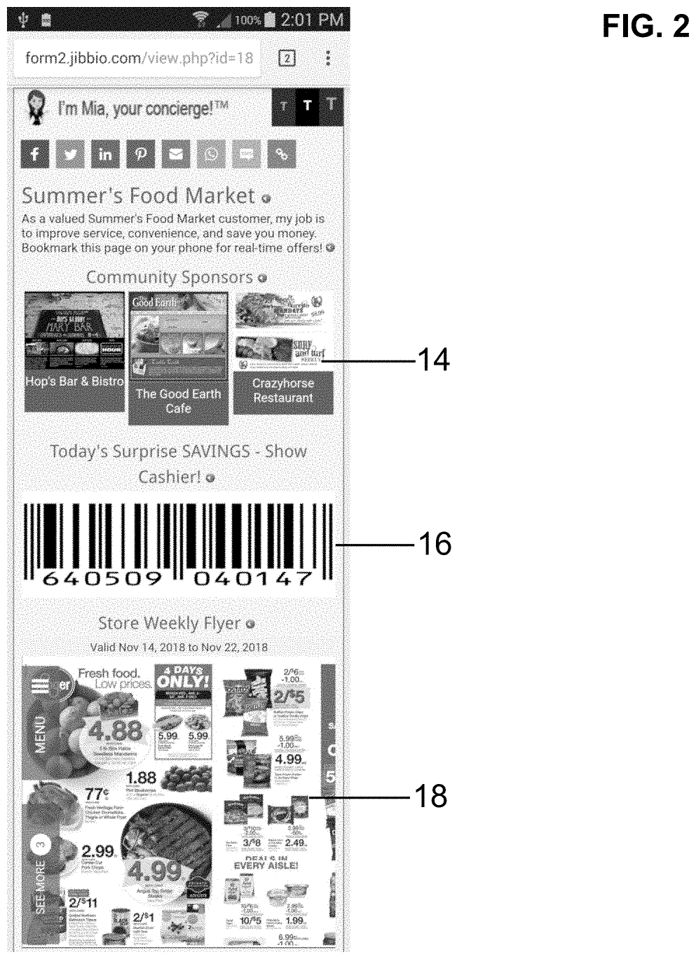

FIG. 2 is a screenshot of a customer's view from the top of the HTML web form, via an Internet enabled user device (e.g. smartphone), showing the upper half of the method and system of this invention.

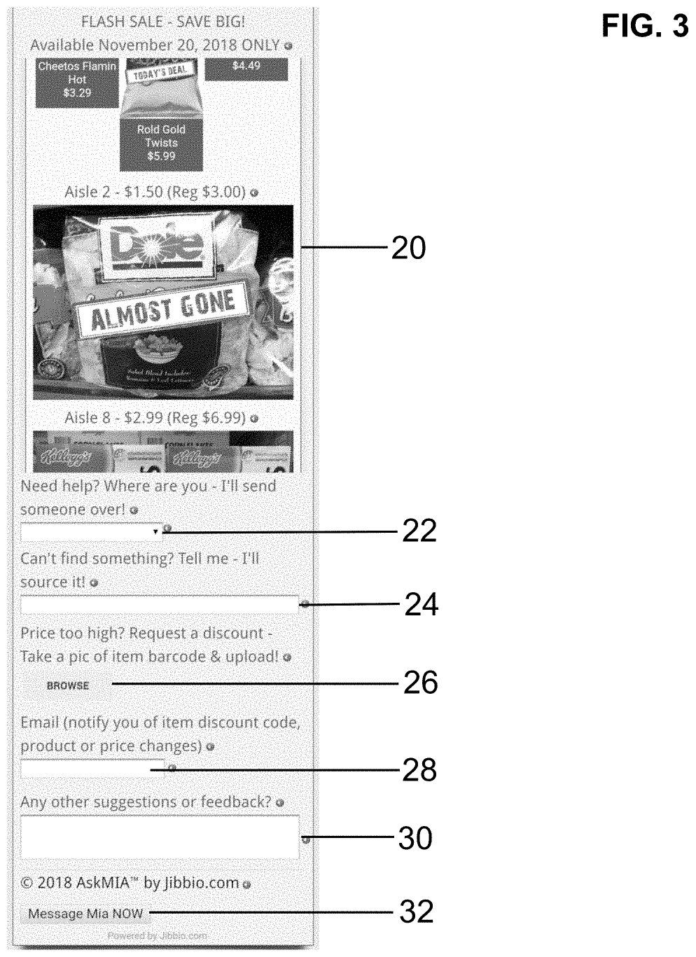

FIG. 3 is a screenshot of a customer's lower view (when the customer scrolls down the page) of the HTML web form, via an Internet enabled user device (e.g. smartphone), showing the lower half of the method and system of this invention.

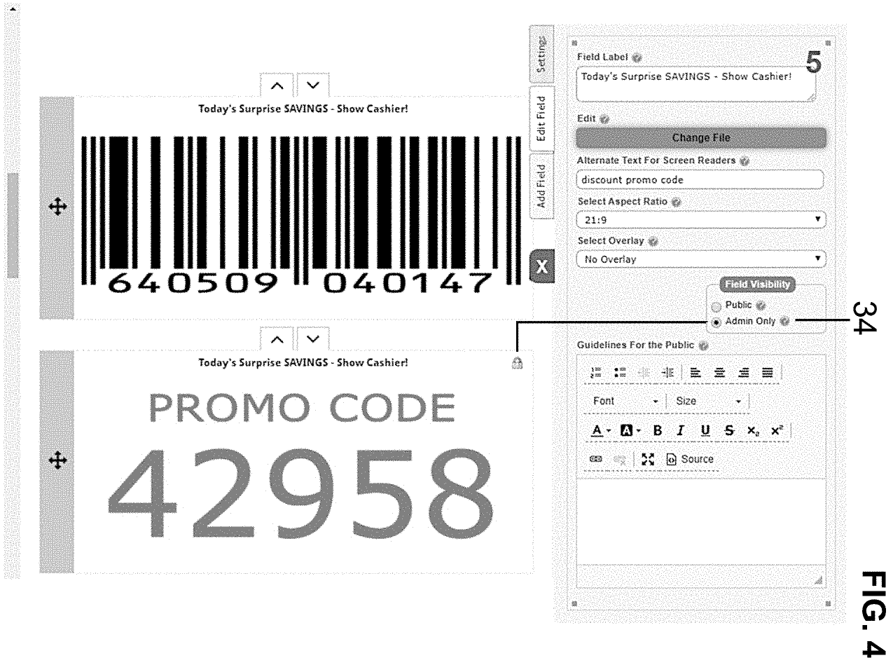

FIG. 4 is a screenshot from a retailer's administrative view of the method and system of this invention, via the user device resident application, showing the ability to pre-upload (file upload function) multiple image formats of discount barcodes or promo codes to the HTML web form. Each barcode or promo code offers a specified “Surprise Savings” discount (e.g. 5% OFF, 10% OFF, 15% OFF, etc.) and are enabled to display publicly or disabled to remain hidden from public view with a click of the mouse, offering customers a checkout discount at the store cashier.

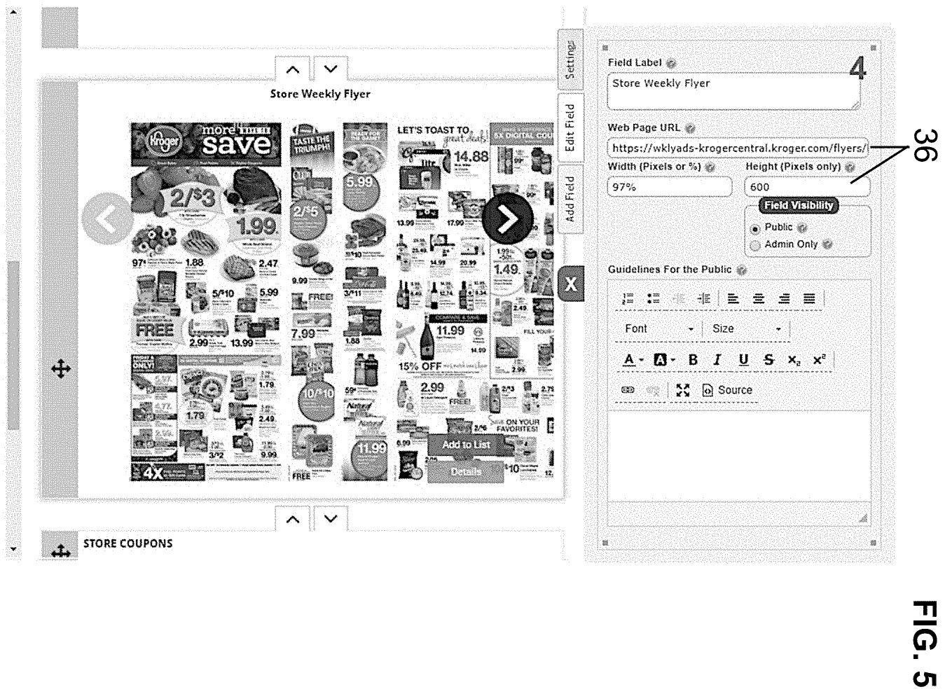

FIG. 5 is a screenshot from a retailer's administrative view of the method and system of this invention, via the user device resident application, showing the ability to enter an external web page URL to display embedded within the HTML web form (e.g. weekly ad flyer or coupons web page).

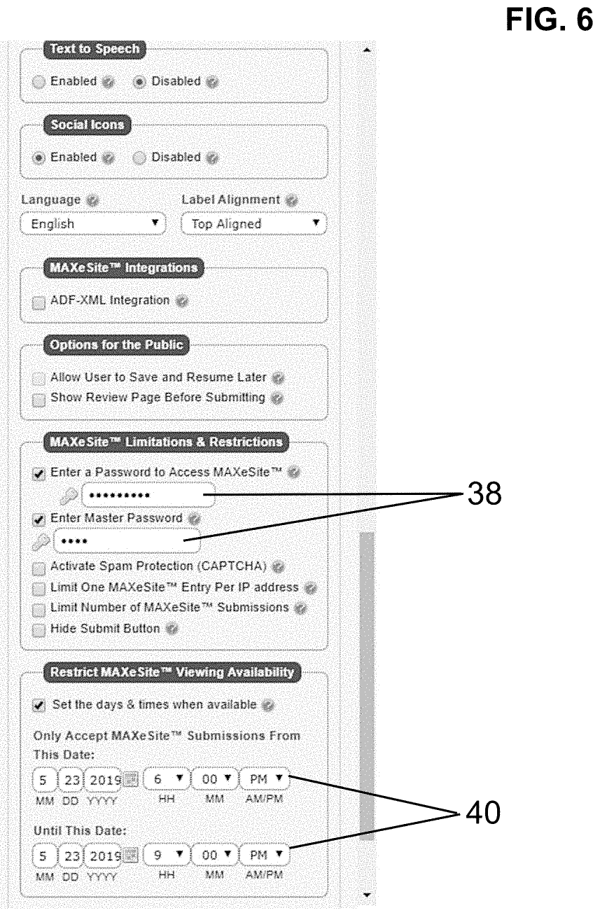

FIG. 6 is a screenshot from a retailer's administrative view of the method and system of this invention, via the user device resident application, showing the ability to apply a password to restrict viewing access, or preset a specified start and end date (including range of time) when the HTML web form is available for viewing by the public.

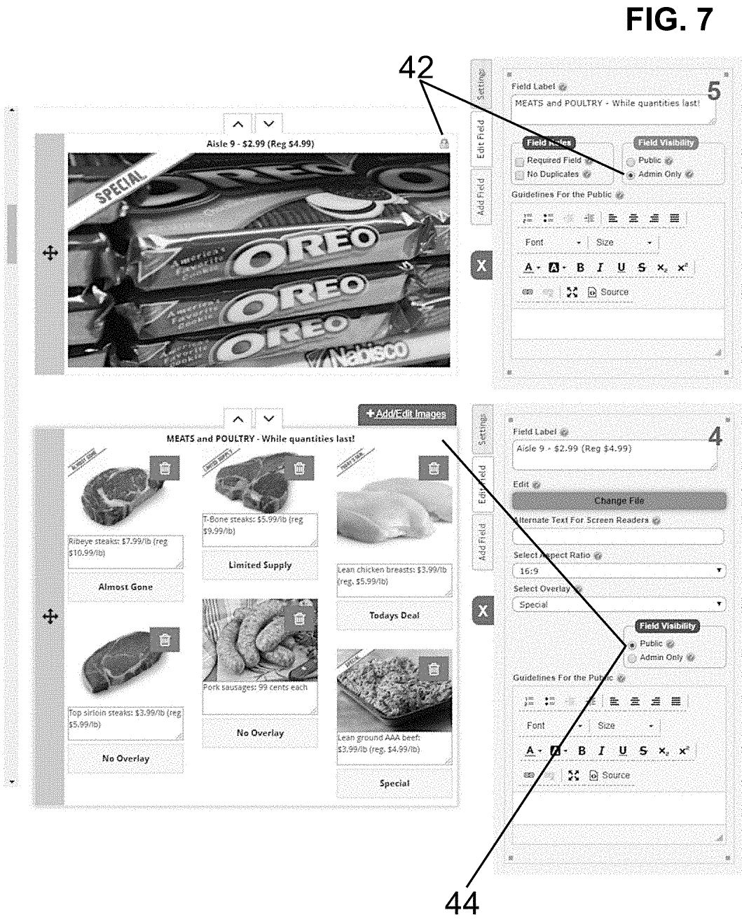

FIG. 7 is a screenshot from a retailer's administrative view of the method and system of this invention, via the user device resident application, showing the ability to create a real-time “Flash, Daily Deal and Clearance” sales with the HTML web form. Preloaded images can be grouped, hidden, edited, deleted, and rearranged at any given time, on the fly.

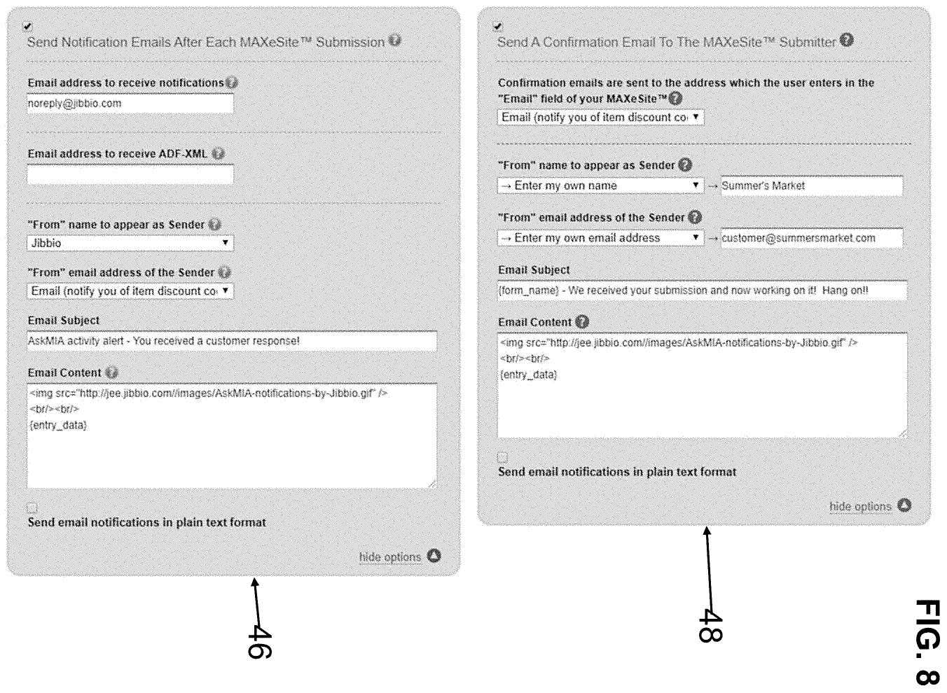

FIG. 8 is a screenshot from a retailer's administrative view of the method and system of this invention, via the user device resident application, showing the ability to preset email autoresponders that are sent to required personnel, management, and/or the customer after the customer has completed a submission via the HTML web form.

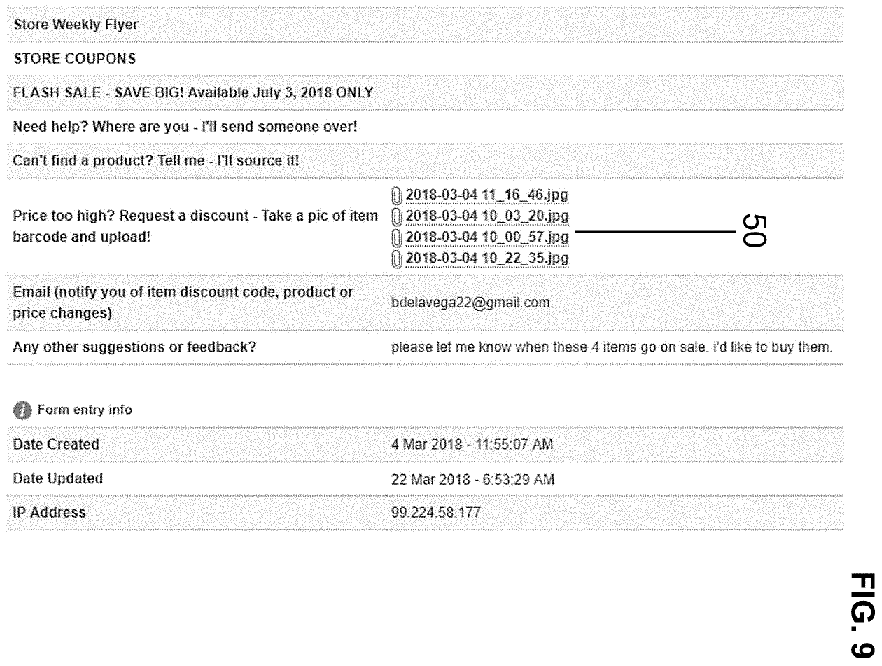

FIG. 9 is a screenshot from a retailer's administrative view of the method and system of this invention, via the user device resident application, showing the customer's submitted information received, with links to each image or media submitted by the customer.

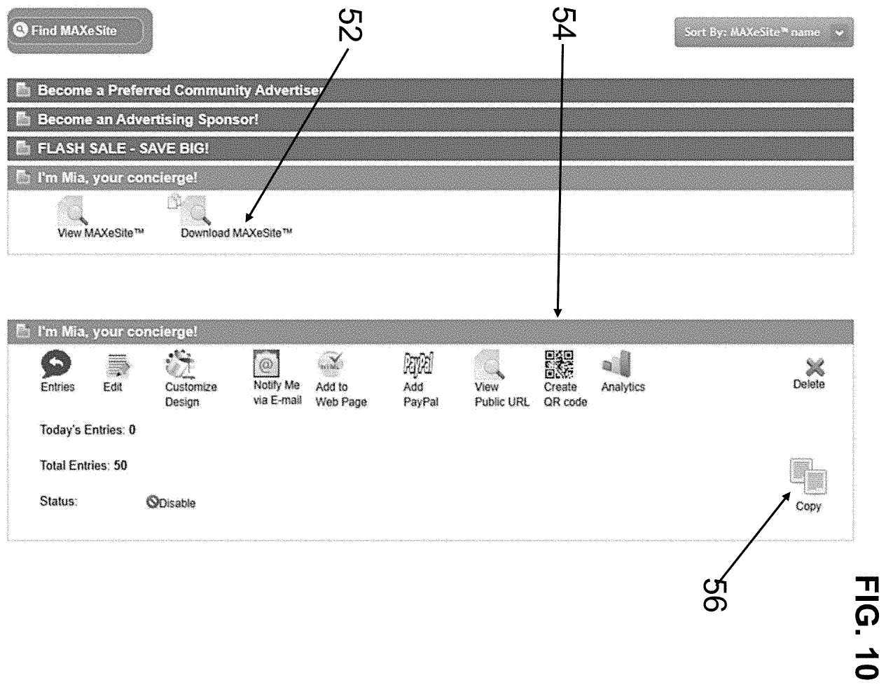

FIG. 10 is a screenshot from a retailer's administrative view of the method and system of this invention, via the user device resident application, showing the ability for retail store locations to download a predesigned HTML web form, customize the template to suit their store needs, and launch in minutes.

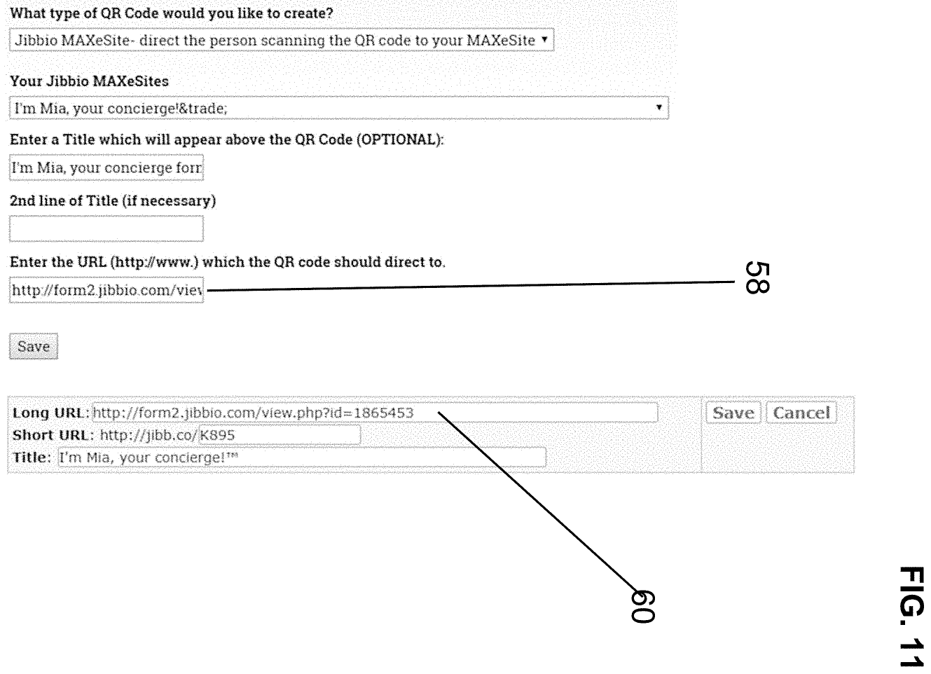

FIG. 11 is a screenshot from a retailer's administrative view of the method and system of this invention, via the user device resident application, showing the ability to edit the destination URL of a QR Code and Short Link on the fly, with the integrated 3-in-1 QR Codes and URL Shortening applications provided with the invention.

### DETAILED DESCRIPTION OF THE INVENTION

FIG. 1 is an image of in-store printed signage used as a method and system of this invention that allows a customer to use their internet enabled user device (e.g. smartphone) to scan a “Quick Response (QR) Code” or enter the “Short Link” displayed, which both direct to the URL of the HTML web form. Alternatively, customers can access the HTML web form URL from any web browser, via an internet enabled user device. Referring to the screenshot, reference numerals are as follows:

10 is the method and system of the customer accessing this invention, by scanning a QR Code using their smartphone.
12 is the alternative method and system of the customer accessing this invention, by manually entering the Short Link in the web browser of their smartphone.

Both methods direct the customer to the same destination URL, the HTML web form.

The retailer can change the destination URL for both QR Code 10 and Short Link 12 on the fly at any given time with the integrated QR Code and URL Shortening applications, explained in more detail in FIG. 12. This provides the retailer with the ability to direct customers to any other URL without having to create and print new QR codes, signage, or short links, saving time and money.

FIG. 2 is a screenshot of a customer's view, via an Internet enabled user device (e.g. smartphone), showing the method and system of this invention. Referring to the screenshot, reference numerals are as follows:

14 is the method and system of this invention showing the ability for a customer to view local business advertisers, acquired by the retailer. This allows retailers to work and develop cross-promotional relationships with local businesses in their community to expand reach. Furthermore, to generate additional revenue for the retailer.
16 is the method and system of this invention showing the ability for a customer to redeem an instant savings, eliminating the costly implications and maintenance of deploying Loyalty or Member Reward programs, as well as implementing dynamic discounts with Point-of-Sale (POS) systems. An image of a “Surprise Savings” discount barcode or promo code, generated with the retailer's Point of Sale (POS) system, entitles the customer to an instant discount when they checkout at the cashier. The cashier would use the retailer's barcode scanner or Point of Sale (POS) hardware capable of scanning barcodes displayed on a smartphone, to scan the image of the discount barcode displayed on the HTML web form, via the customer's smartphone to apply the savings. If the retailer's barcode scanner or Point of Sale (POS) hardware does not have the capability (e.g. laser scanners) of scanning the barcode image directly from the customer's smartphone, the cashier would enter the barcode numbers to apply the discount. Similarly, the cashier would also enter the promo code numbers associated with an image of a promo code displayed on the HTML web form.
18 is the method and system of this invention showing the ability for a customer to view external web pages such as the retailer's weekly flyer or digital coupons, IFramed (embedded) within a section of the HTML web form. This provides customers with the convenience of not having to search the retailer's website or view multiple pages that may require too many steps to access info (e.g. enter their City or Zip code, then peruse through multiple listings before selecting their exact retail store location), and/or may not be user-friendly.

FIG. 3 is a screenshot of a customer's lower view (second half of the page when customer scrolls down), via an Internet enabled user device (e.g. smartphone), showing the method and system of this invention. Referring to the screenshot, reference numerals are as follows:

20 is the method and system of this invention showing the ability for a customer to view an HTML web form comprising of real-time special offers such as “Flash, Daily Deal or Clearance” sales, IFramed (embedded) within a section of the HTML web form. A customer can view discounted or promotional products during a specific time, in real-time, applicable for the retail store location.

This enables customers to be informed of “Flash, Daily Deal and Clearance” products available for purchase at a significant savings in real-time, relevant to the time when the customer is shopping, compared to other conventional methods of communication such as email marketing and printed flyers, which may not be viewed by the customer or the sale items may not be available (e.g. item sold out) during the customer's in-store visit.

In turn, this enables retailers to shorten the sales cycle of prioritized inventory (e.g. perishables, seasonal, open box, clearance, demos, and excess stock) to increase sales revenue and reduce losses. Furthermore, minimizing the percentage of unsold products sitting on store shelves over a prolonged period.

22 is the method and system of this invention showing the ability for a customer to simply click a field (e.g. drop-down) on the HTML web form that displays areas within the retail store location (e.g. Aisle 10, Aisle 11, Garden Center, etc.), select their location, and then click the “Message Mia NOW” button to transmit an automated email notification to required store personnel, who in turn can assist the customer on the store floor. This eliminates the inconvenience for customers having to physically search for store personnel when they require assistance, especially during slower times when less store staff are available, as well as for larger retail stores.
24 is the method and system of this invention showing the ability for a customer to enter the name of a product that they are looking for, or products that may not be available for purchase within the store, in the field provided. Customer enters their email address to be notified by the retailer if or when those products become available, and then clicks the “Message MIA now” button to submit their inquiry, received by store personnel via email.
26 is the method and system of this invention showing the ability for a customer to use the smartphone camera to take a picture of the barcode of each product they wish to purchase pending a price reduction, click the “Browse” button to upload the product barcode image(s), and then enter their email address to request a product discount while in-store, or to be notified by the retailer when the price of desired products have been reduced at a future date. Alternatively, the customer can suggest price changes on products they wish to buy in the field provided 30, and then be notified via email 28 when retailer has satisfied their requests.
28 is the method and system of this invention used by the customer to enter their email address to be notified by the retailer for information pertaining to 24 and 26.
30 is the method and system of this invention used by the customer to enter additional information pertaining to 24, 26, or to submit general feedback and suggestions.
32 is the method and system of this invention used by the customer to submit their information electronically, which in turn transmits an email notification to required parties preset by the retailer.

FIG. 4 is a screenshot from a retailer's administrative view of the method and system of this invention, via the user device resident application, showing the ability to pre-upload (file upload function) multiple image formats of discount barcodes or promo codes to the HTML web form. The retailer first creates discount barcodes or promo codes using their existing Point of Sale (POS) system or applicable retail management software, with each discount barcode or promo code offering a specified “Surprise Savings” discount (e.g. 5% OFF, 10% OFF, 15% OFF, etc.) for the customer when they checkout at the store cashier. Once a discount barcode or promo code is produced, the retailer then creates a digital image format such as JPG, PNG, or GIF for each discount barcode or promo code. Referring to the screenshot, reference numeral is as follows:

34 is the method and system of this invention used by the retailer to toggle “ON/OFF” with a click of the mouse, preloaded discount barcode or promo code image(s) from displaying within the public HTML web form, at any given time.
The procedure is as follows:
a. Retailer creates discount barcodes or promo codes using their existing Point of Sale (POS) or any software they use to generate discounts for customers.
b. Retailer uses a scanner or camera to create a digital image format (e.g. JPG, PNG, GIF) for each discount barcode or promo code produced, as each one entitles the customer to a specified discount.
c. Retailer pre-uploads (file upload function) the discount barcode or promo code image(s) to the HTML web form.
d. To publicly display a discount barcode or promo code image within the HTML web form, the retailer selects the “Public” option in the Form Field Visibility setting using their computer mouse (to toggle “ON”). To hide a discount barcode or promo code image from displaying publicly within the HTML web form, the retailer selects “Admin only” in the Form Field Visibility setting 34 (to toggle “OFF”). Images that are “Admin only” (not displayed within the HTML web form) will display a “lock” icon 34 in the top right corner of the image, and images publicly displayed will not display the “lock” icon, to advise the retailer of its status as shown in the screen shot. This enables the retailer to see which image(s) are publicly available without having to click on each image to determine the viewing status. The retailer can change the viewing status of each discount barcode or promo code image on the fly, at any given time.
e. Every time the customer views the HTML web form on an Internet enabled user device (e.g. smartphone), the appropriate discount barcode or promo code image(s) are displayed (i.e. toggled “ON”) and therefore available for redemption by the customer.
f. Cashier working at retailer uses their Point of Sale (POS) barcode scanner or system to scan the discount barcode or promo code image(s) displayed in the HTML web form, via customer's Internet enabled user device (e.g. smartphone), to apply the applicable discount 16. If the retailer's existing Point of Sale (POS) barcode scanner or system is not capable of scanning barcodes directly from a customer's smartphone, the cashier would enter the barcode numbers to apply the discount. Similarly, the cashier would also enter applicable promo code numbers associated with an image of a promo code. No loyalty, rewards, or membership cards required.

Using images of discount barcodes or promo codes is an easy and efficient marketing solution allowing retailers to offer customers dynamic discounts on the fly that can be changed on a minute, hourly, daily, or weekly basis using the one-click “Public” (display) or “Admin only” (hidden) functionality. As a result, customers receive instant gratification every time they shop at the retailer, which in turn encourage customers to use the invention FIG. 2 and FIG. 3 regularly, increasing customer loyalty and sales.

This eliminates the complexities involved with conventional implementation of barcode changes in current Point of Sale (POS) or applicable product management software, which requires time and personnel for retail management to execute. Moreover, the method and system of this invention allows retailers to tailor specified discount savings to suit the needs of each store to optimize micro marketing, as each retail location vary in sales and customer demographics.

FIG. 5 is a screenshot of a retailer's administrative view of the method and system of this invention, via the user device resident application, showing the ability for a retailer to enter an external web page URL (e.g. retailer's weekly ad flyer web page) to display IFramed (embedded) within a section of the HTML web form. Referring to the screenshot, reference numerals is as follows:

36 is the method and system of this invention used by the retailer to enter an external web page URL to display IFramed within a section of the HTML web form, enter the width and height layout of the IFramed section, and change the web page URL on the fly at any given time. The retailer can embed multiple IFrames of external web pages within the HTML web form.

This eliminates the need for retailers to direct customers to their corporate website, which may offer too much content, may not be user-friendly, and/or requires too many navigational mouse clicks to access information, which can be frustrating for customers. In addition, this empowers retailers to directly promote and market multiple web pages to customers, which they can change on the fly at any given time.

FIG. 6 is a screenshot from a retailer's administrative view of the method and system of this invention, via the user device resident application, showing the ability to apply a password to restrict viewing access, or preset a specified start and end date (date and time) when the HTML web form is available for public viewing. Referring to the screenshot, reference numerals are as follows:

38 is the method and system of this invention used by the retailer to apply a password required for the public to view and access the HTML web form.
40 is the method and system of this invention used by the retailer to select a start date, end date, start time, and end time, when the HTML web form is available for public viewing.

FIG. 7 is a screenshot from a retailer's administrative view of the method and system of this invention, via the user device resident application, showing the ability to create real-time special product offers such as “Flash, Daily Deal or Clearance” sales in the HTML web form. The retailer can restrict public viewing access of the HTML web form by entering a start date, end date, start time, and end time in reference to FIG. 6, Numeral 40. Alternatively, the retailer can restrict public viewing access of the HTML web form by applying a password in reference to FIG. 6, Numeral 38. The retailer preloads (upload function) product images that can be grouped, hidden, edited, deleted, and rearranged at any given time, on the fly. Referring to the screenshot, reference numerals are as follows:

42 is the method and system of this invention used by the retailer to pre-upload (file upload function) single images of products or items for sale, to a single image field, with the ability to select the image fields that should display publicly in the HTML web form. Images that are “Admin only” (not displayed in the HTML web form) will display a “lock” icon in the top right corner of the image, and images publicly displayed in the HTML web form will not display the “lock” icon. This enables the retailer to see which single image field(s) are publicly available without having to click on each image field to determine the viewing status. This allows the retailer to organize and display priority products in inventory that need to be sold (e.g. perishables, seasonal, open box, demo, clearance, excess stock, sitting inventory, etc.).
44 is the method and system of this invention used by the retailer to pre-upload (file upload function) multiple images of products or items for sale, to a multiple images gallery field, with the ability to select the multiple images gallery fields that should display publicly in the HTML web form. Images that are “Admin only” (not displayed within the web form) will display a “lock” icon in the top right corner of the image, and images publicly displayed will not display the “lock” icon. This enables the retailer to see which multiple images gallery field(s) are publicly available without having to click on each image field to determine the viewing status. Multiple image gallery fields are ideal for retailers to organize and promote products within a specific department, aisle, section, or category within the retail store.

FIG. 8 is a screenshot from a retailer's administrative view of the method and system of this invention, via the user device resident application, showing the ability to create email autoresponders, which is simultaneously emailed to required parties, management, and/or the customer upon completion of a form submission in reference to FIG. 2 and FIG. 3. Referring to the screenshot, reference numeral are as follows:

46 is the method and system of this invention used by the retailer to enter their desired email autoresponder information sent to required parties (e.g. management); comprising the Sender's Name, Sender's email address, multiple recipients, and a custom message.
48 is the method and system of this invention used by the retailer to enter their desired email autoresponder information sent to the form submitter (i.e. customer); comprising the Sender's Name, Senders' email address, and a custom message.

This eliminates the need for store retail management to manually notify and relay information to other required parties such as head office or upper management. Moreover, it enables head office or upper management to automatically receive a copy of each customer form submission to monitor customer activity on a per store location basis.

FIG. 9 is a screenshot from a retailer's administrative view of the method and system of this invention, via the user device resident application, showing the ability to view the customer's submitted information (i.e. form data) received, which includes web links that direct to each image or media file provided (uploaded) by the customer. The retailer can edit each customer's submitted information and filter information as desired. The retailer can export the data from select customers or information from all customers in a comma-separated value (CSV) or text (TXT) file for offline use, or to build the retailer's opt-in email marketing customer base. In addition, the retailer can print or email the data received from select customers as required. Referring to the screenshot, reference numeral is as follows:

50 is the method and system of this invention used by the retailer to view the customer's submitted information, which includes web links that direct to each image or media file provided (uploaded) by the customer such as product barcode image(s), in reference to FIG. 3, Numeral 26. For product barcode image(s), the retailer clicks each web link to download and view the images files, then scans the barcode images with their barcode scanner to input the request into their Point of Sale (POS) or appropriate product management system to obtain more product information.

If the retailer's barcode scanner or Point of Sale (POS) hardware does not have the capability of scanning a product barcode image displayed on a computer screen (e.g. laser scanners), retail personnel would enter the product's barcode numbers to register the item into the retailer's system. Alternatively, retailer personnel can print the product's barcode image on paper and then scan it using the barcode scanner device.

FIG. 10 is a screenshot from a retailer's administrative view of the method and system of this invention, via the user device resident application, showing the ability for retail locations to download the predesigned invention FIG. 2 and FIG. 3, customize to suit their individual store needs, and launch in minutes. Referring to the screenshot, reference numeral are as follows:

52 is the method and system of this invention used by each retail store location to download predesigned HTML web form templates for a turnkey and quick launch, without time-consuming setup.
54 is the method and system of this invention used by each retail store location to customize the predesigned HTML web form template to suit their needs.
56 is the method and system of this invention used by each retail store location to copy the customized predesigned HTML web form template for other retail store locations.

This eliminates the need for retailers to develop from scratch, setup and configure the invention for each of its store locations, a feature valuable for retailers with multiple locations. Each store location can download and customize the predesigned HTML web form template to manage the needs of their particular store and customer demographics. Moreover, to save time, money, and increase micro marketing efficiency.

FIG. 11 is a screenshot from a retailer's administrative view of the method and system of this invention, via the user device resident application, showing the ability for a retailer to edit the destination URL of a QR Code and Short Link on the fly, with the integrated 3-in-1 QR Codes and URL Shortening applications. Referring to the screenshot, reference numerals are as follows:

58 is the method and system of this invention used by each retail store location to change the destination URL of a QR Code (e.g. use the same QR Code to direct customers to any HTML web form or web page URL)
60 is the method and system of this invention used by each retail store location to change the destination URL of a Short Link (e.g. use the same Short Link to direct customers to any HTML web form or web page URL)

This eliminates the need for retailers to reprint signage to accommodate the new QR Code or Short Link, saving the retailer time and money.

While the present invention has been described in terms of particular embodiments and applications, in both summarized and detailed forms, it is not intended that these descriptions in any way limit its scope to any such embodiments and applications, and it will be understood that many substitutions, changes and variations in the described embodiments, applications and details of the method and system illustrated herein and of their operation can be made by those skilled in the art without departing from the spirit of this invention.

What is claimed is:

1. A method carried out on an internet enabled user device for enhancing the in-store customer shopping experience, via a user-interactive multimedia HTML (hypertext markup language) web form with one or more HTML user-interactive fields, wherein the user device is capable of displaying, in cooperation with a user device resident application, shopping items, information and discounts for the customer, in cooperation with the user device resident application, wherein the user device resident application comprises a functionality that determines user-interactive fields to display or remain hidden from public view in the HTML web form, via the user device, comprising:
(i) displaying the HTML web form on the user device;
(ii) displaying on the user device, in cooperation with the user device resident application, an image of one or more discount barcodes or promo codes that offer customers a discount at checkout;
(iii) displaying on the user device, in cooperation with the user device resident application, multiple images of products and items offered at a special price;
(iv) transmitting, via the HTML web form displaying on the user device, an image of the barcode of one or more products taken with a smartphone camera, via user device, as a method for the customer to advise the retailer of products they wish to purchase and request a discount while in-store;
(v) transmitting, via the HTML web form displaying on the user device, an ability for the customer to request in-store assistance by selecting their location listed in a form field;
(vi) displaying on the user device, in cooperation with the user device resident application, the HTML web form comprising one or more IFrames (Inline Frame HTML element) of a web page or image URL from another source, such as weekly ad flyers or discount coupons;
(vii) displaying on the user device, in cooperation with the user device resident application, the HTML web form comprising one or more IFrames (Inline Frame HTML element) of another HTML web form comprising of real-time special offers or flash sales, to inform customers of discounted sale items during their shopping visit;
(viii) transmitting, via the HTML web form displaying on the user device, an ability for customer to inquire about products unavailable for purchase in-store; and
(ix) transmitting, via the HTML web form displaying on the user device, an ability for customer to submit feedback and suggestions with optional anonymity.

2. The method of claim 1, wherein user device accesses said HTML web form by entering the HTML web form URL in a web browser or scanning a QR Code displayed on print signage using Internet enabled user device, requiring no registration or login for access by user device as shown and described herein.

3. The method of claim 1, wherein said HTML web form public URL displays auto-refresh content when accessed, content changed via the user device resident application, as shown and described herein.

4. The method of claim 1, wherein the HTML user-interactive fields of the HTML web form comprise: a single image, a multiple images gallery, a file upload, a drop-down, an IFrame (Inline Frame HTML element), an email, or a free text area.

5. The method of claim 1, wherein said HTML user-interactive fields of the HTML web form comprise a control, via the user device resident application, to determine if HTML user-interactive fields display publicly or remain hidden from public view in said HTML web form, as shown and described herein.

6. The method of claim 1, wherein said HTML user-interactive fields of the HTML web form are edited, deleted, moved, copied, or new fields added, via the user device resident application, as shown and described herein.

7. The method of claim 1, wherein said HTML web form comprises a single image field, to display and control the public visibility of said discount barcode or promo code images displayed in HTML web form, via the user device, as a method for the retailer to offer a plurality of said discount savings or promo codes for customers at checkout, changed via the user device resident application, as shown and described herein.

8. The method of claim 7, wherein said control for the public visibility of said discount barcode or promo code single image fields in HTML web form, via the user device resident application, determine if said discount barcode or promo code single image fields display publicly or remain hidden from public view in said HTML web form, as shown and described herein.

9. The method of claim 1, wherein said HTML web form comprises a multiple images gallery field, to control the public visibility of said multiple images of products and special offers displayed in HTML web form, via the user device, as a method for the retailer to pre-upload one or more multiple images gallery fields, select desired multiple images gallery fields to display publicly, changed via the user device resident application, as shown and described herein.

10. The method of claim 9, wherein said control for the public visibility of said multiple images gallery fields in HTML web form, via the user device resident application, determine if said multiple images gallery fields display publicly or remain hidden from public view in said HTML web form, as a method for the retailer to inform customers of products and special offers during their shopping visit, as shown and described herein.

11. The method of claim 1, wherein said control for the public visibility of said Frames in HTML web form, via the user device resident application, determine if said Frames display publicly or remain hidden from public view in said HTML web form, as shown and described herein.

12. The method of claim 11, wherein public viewing access of Iframe in HTML web form is restricted with a password or public visibility start and end dates, via the user device resident application, as shown and described herein.

13. The method of claim 1, wherein said HTML web form comprises an email field, as a method for communication between retailer and customer, for retailer to email customer product discount(s), or to notify customer of price reduction on products.

14. The method of claim 1, wherein said HTML web form comprises a file upload field, as a method for the customer to take a picture with smartphone camera via user device, of the said barcode of one or more products they wish to purchase, upload images via the file upload field to transmit items to the retailer, and request a discount via the free text area field, as shown and described herein.

15. The method of claim 1, wherein said image of the barcode of one or more products taken with a smartphone camera, via internet enabled user device, further comprising:
internet enabled user device;
HTML web form;
user device displaying HTML web form;
the user taking a picture of the barcode of one or more products with the user device camera;
the user uploading product barcode images, via the internet enabled user device, to HTML web form displaying in user device;
the user requesting a discount via the free text area field, via the HTML web form displayed in the internet enabled user device;
the user entering their email address and submitting their request;
images and discount request submitted by the user transmitting via email to one or more retailer personnel; and
retailer emailing product discount code or notification of product price reduction, to the user.

16. A system comprising an (a) internet enabled user device capable of communicating with a user device resident application, and (b) computer instructions executable by the user device resident application, for enhancing the in-store customer shopping experience, via a user-interactive multimedia HTML (hypertext markup language) web form with one or more HTML user-interactive fields, wherein the user device is capable of displaying, in cooperation with the user device resident application, shopping items, information and discounts for the customer, in cooperation with the user device resident application, wherein the user device resident application comprises a functionality that determines user-interactive fields to display or remain hidden from public view in the HTML web form, the instructions, when executed, causing the user device to:
(i) display the HTML web form on the user device;
(ii) display on the user device, in cooperation with the user device resident application, an image of one or more discount barcodes or promo codes that offer customers a discount at checkout;
(iii) display on the user device, in cooperation with the user device resident application, multiple images of products and items offered at a special price;
(iv) transmit, via the HTML web form displayed on the user device, an image of the barcode of one or more products taken with a smartphone camera, via user device, as a method for customer to advise retailer of products they wish to purchase and request a discount while in-store;
(v) transmit, via the HTML web form displayed on the user device, an ability for customer to request in-store assistance by selecting their location listed in a form field;
(vi) display on the user device, in cooperation with the user device resident application, the HTML web form comprising one or more IFrames (Inline Frame HTML element) of a web page or image URL from another source, such as weekly ad flyers or discount coupons;
(vii) display on the user device, in cooperation with the user device resident application, the HTML web form comprising one or more IFrames (Inline Frame HTML element) of another HTML web form comprising of real-time special offers or flash sales, to inform customers of product specials during their shopping visit;
(viii) transmit, via the HTML web form displayed on the user device, an ability for customer to inquire about products unavailable for purchase in-store; and
(ix) transmit, via the HTML web form displayed on the user device, an ability for customer to submit feedback and suggestions with optional anonymity.

17. The system of claim 16, wherein the HTML user-interactive fields of the HTML web form comprise: a single image, a multiple images gallery, a file upload, a drop-down, an IFrame (Inline Frame HTML element), an email, or a free text area.

18. The system of claim 16, wherein said HTML user-interactive fields of the HTML web form comprise a control, via the user device resident application, to determine if HTML user-interactive fields display publicly or remain hidden from public view in said HTML web form, as shown and described herein.

19. The system of claim 16, wherein said HTML user-interactive fields of the HTML web form are edited, deleted, moved, copied, or new fields added, via the user device resident application, as shown and described herein.

20. The system of claim 16, wherein said control for the public visibility of said discount barcode or promo code single image fields in HTML web form, via the user device resident application, determine if said discount barcode or promo code single image fields display publicly or remain hidden from public view in said HTML web form, as shown and described herein.
